(19) United States
(12) Patent Application Publication
(10) Pub. No.: US 2026/0333307 A1
(43) Pub. Date: Oct. 22, 2026

(54) METHOD FOR MONITORING OR SENDING INFORMATION, APPARATUS, DEVICE, AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/122,456

(22) PCT Filed: Oct. 21, 2022
(86) PCT No.: PCT/CN2022/126794

§ 371 Date: Apr. 18, 2025

(51) Int. Cl. H04W 72/044; H04W 24/08; H04W 72/11

(52) U.S. Cl. CPC H04W 72/044; H04W 72/11; H04W 24/08

(57) ABSTRACT

A method for monitoring information is performed by a user equipment, and includes: receiving first resource configuration information and second resource configuration information, where the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and in response to the first time-frequency resource and the second time-frequency resource having an overlapping region, not monitoring, on the overlapping region, one of the first channel and the second channel.

### CROSS REFERENCE TO RELATED APPLICATIONS

This application is a National Phase of International Application No. PCT/CN2022/126794, filed on Oct. 21, 2022, the entire contents of which are incorporated herein by reference in their entireties.

### TECHNICAL FIELD

The present disclosure relates to the field of communication technologies, in particular to a method and apparatus for monitoring information, a method and apparatus for transmitting information, a device, and a storage medium.

### BACKGROUND

In order to save power consumption of a user equipment (UE), a main transceiver and a low-power receiver are provided in the UE. The user equipment can make the main transceiver in a sleep state, make the low-power receiver monitor the low-power wake-up signal (LP WUS), wake up the main transceiver after the LP WUS is monitored, and receive and transmit data through the main transceiver. The LP WUS is broadcast by the base station.

Because the UE is provided with both the main transceiver and the low-power receiver, there are multiple UEs in a cell at the same time, and both the user equipment and the base station need to deal with the coexistence problem of the LP WUS applied to the low-power reception and the signal applied to the main transceiver. It is necessary to consider whether the configuration of the time-frequency resource of the first channel for the main transceiver and the time-frequency resource of the second channel for the low-power receiver will affect the monitoring.

### SUMMARY

Embodiments of the present disclosure provide a method and apparatus for monitoring information, a method and apparatus for transmitting information, a device, and a storage medium.

According to a first aspect of the embodiments of the present disclosure, there is provided a method for monitoring information, performed by a user equipment, and including: receiving first resource configuration information and second resource configuration information, where the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and in response to the first time-frequency resource and the second time-frequency resource having an overlapping region, not monitoring, on the overlapping region, one of the first channel and the second channel.

In some embodiments, not monitoring, on the overlapping region, one of the first channel and the second channel includes: based on a priority of the first channel and a priority of the second channel, not monitoring, on the overlapping region, one with a lower priority of the first channel and the second channel.

In some embodiments, not monitoring, on the overlapping region, one of the first channel and the second channel includes: in response to the first channel being a physical downlink control channel (PDCCH) candidate, not monitoring, on the overlapping region, the first channel.

In some embodiments, not monitoring, on the overlapping region, one of the first channel and the second channel includes: in response to the first channel being a physical downlink shared channel (PDSCH), not monitoring, on the overlapping region, the first channel.

In some embodiments, not monitoring, on the overlapping region, one of the first channel and the second channel includes: in response to the first channel being used by a reference signal, not monitoring, on the overlapping region, the first channel.

In some embodiments, not monitoring, on the overlapping region, one of the first channel and the second channel includes: in response to the first channel being used by a synchronization signal, not monitoring, on the overlapping region, the second channel.

According to a second aspect of the embodiments of the present disclosure, there is provided a method for transmitting information, performed by a network device, and including: transmitting first resource configuration information and second resource configuration information to a user equipment, where the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and in response to the first time-frequency resource and the second time-frequency resource having an overlapping region, not transmitting, on the overlapping region, one of the first channel and the second channel.

In some embodiments, not transmitting, on the overlapping region, one of the first channel and the second channel includes: based on a priority of the first channel and a priority of the second channel, not transmitting, on the overlapping region, one with a lower priority of the first channel and the second channel.

In some embodiments, not transmitting, on the overlapping region, one of the first channel and the second channel includes: in response to the first channel being a physical downlink control channel (PDCCH) candidate, not transmitting, on the overlapping region, the first channel.

In some embodiments, not transmitting, on the overlapping region, one of the first channel and the second channel includes: in response to the first channel being a physical downlink shared channel (PDSCH), not transmitting, on the overlapping region, the first channel.

In some embodiments, not transmitting, on the overlapping region, one of the first channel and the second channel includes: in response to the first channel being used by a reference signal, not transmitting, on the overlapping region, the first channel.

In some embodiments, not transmitting, on the overlapping region, one of the first channel and the second channel includes: in response to the first channel being used by a synchronization signal, not transmitting, on the overlapping region, the second channel.

According to a third aspect of the present disclosure, there is provided an electronic device, including a processor and a memory, where the memory is configured to store computer programs; and the computer programs, when executed by the processor, cause the processor to perform the method according to the first aspect.

According to a fourth aspect of the present disclosure, there is provided an electronic device, including a processor and a memory, where the memory is configured to store computer programs; and the computer programs, when executed by the processor, cause the processor to perform the method according to the second aspect.

According to a fifth aspect of the present disclosure, there is provided a non-transitory computer-readable storage medium, storing instructions thereon, where the instructions, when executed by a processor, cause the processor to perform the method according to the first aspect.

According to a sixth aspect of the present disclosure, there is provided a non-transitory computer-readable storage medium, storing instructions thereon, where the instructions, when executed by a processor, cause the processor to perform the method according to the second aspect.

It is to be understood that the above general descriptions and the below detailed descriptions are merely exemplary and explanatory, and are not intended to limit the present disclosure.

### BRIEF DESCRIPTION OF THE DRAWINGS

The drawings described here are used to provide a further understanding of the present specification and constitute a part of the present disclosure. The schematic implementations of the present disclosure and the description thereof are used to explain the present disclosure, and do not constitute an improper limitation on the present disclosure. Among the drawings:

The accompanying drawings, which are incorporated in and constitute a part of this specification, illustrate embodiments consistent with the present disclosure and, together with the description, serve to explain the principles of the disclosure.

FIG. 1 is a schematic diagram illustrating a wireless communication system architecture according to an embodiment of the present disclosure.

FIG. 2 is a schematic diagram illustrating a method for monitoring information according to an embodiment of the present disclosure.

FIG. 3 is a schematic diagram illustrating a method for monitoring information according to another embodiment of the present disclosure.

FIG. 4 is a schematic diagram illustrating a method for monitoring information according to yet another embodiment of the present disclosure.

FIG. 5 is a schematic diagram illustrating a method for monitoring information according to still another embodiment of the present disclosure.

FIG. 6 is a schematic diagram illustrating a method for monitoring information according to still another embodiment of the present disclosure.

FIG. 7 is a schematic diagram illustrating a method for monitoring information according to still another embodiment of the present disclosure.

FIG. 8 is a schematic diagram illustrating a method for monitoring information according to still another embodiment of the present disclosure.

FIG. 9 is a schematic diagram illustrating a method for monitoring information according to still another embodiment of the present disclosure.

FIG. 10 is a schematic diagram illustrating a method for transmitting information according to an embodiment of the present disclosure.

FIG. 11 is a schematic diagram illustrating a method for transmitting information according to another embodiment of the present disclosure.

FIG. 12 is a schematic diagram illustrating a method for transmitting information according to yet another embodiment of the present disclosure.

FIG. 13 is a schematic diagram illustrating a method for transmitting information according to still another embodiment of the present disclosure.

FIG. 14 is a structural schematic diagram illustrating an apparatus for monitoring information according to an embodiment of the present disclosure.

FIG. 15 is a structural schematic diagram illustrating a device for monitoring information according to an embodiment of the present disclosure.

FIG. 16 is a structural schematic diagram illustrating an apparatus for transmitting information according to an embodiment of the present disclosure.

FIG. 17 is a structural schematic diagram illustrating a device for transmitting information according to an embodiment of the present disclosure.

### DETAILED DESCRIPTION OF THE EMBODIMENTS

The embodiments of the present disclosure will be further described in detail below in conjunction with accompanying drawings and specific examples.

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

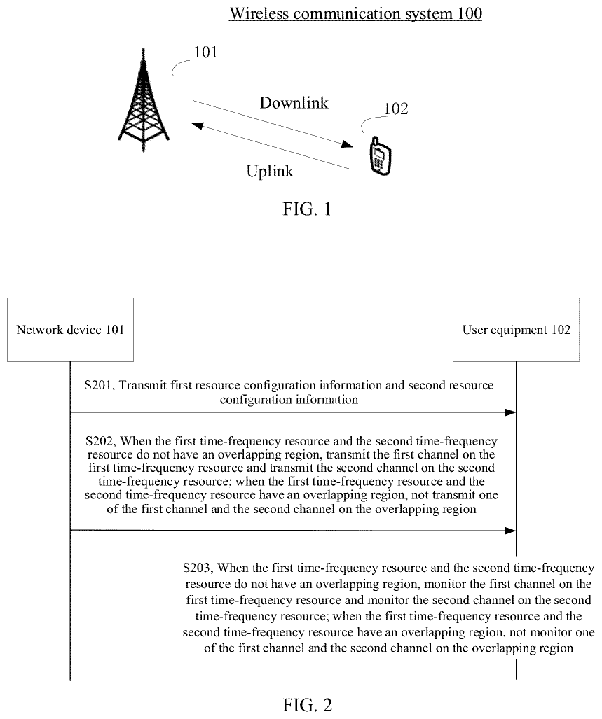

As shown in FIG. 1, an embodiment of the present disclosure provides a method for executing indication information that can be applied to a wireless communication system 100, which may include, but is not limited to, a network device 101 and a user equipment 102. The user equipment 102 is configured to support carrier aggregation, and the user equipment 102 may be connected to a plurality of carrier units of the network device 101, including a primary component carrier unit and one or more secondary component carrier units.

It will be understood that the wireless communication system 100 may be suitable for both low frequency and high frequency scenes. The application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) systems, a future 5th-generation (5G) system, a new radio (NR) communication system, a future evolved public land mobile network (PLMN) system, and other systems.

The user equipment 102 may be a user equipment (UE), a terminal, an access terminal, a terminal unit, a terminal station, a mobile station (MS), a remote station, a remote terminal, a mobile terminal, a wireless communication device, a terminal agent, etc. The user equipment 102 may have a wireless receiving and transmitting function, which is capable of communicating (e.g., wireless communication) with one or more network devices 101 of one or more communication systems and accepting network services provided by the network devices 101, which herein include, but are not limited to, a base station illustrated.

The user equipment 102 may be a cellular telephone, a cordless telephone, a session initiation protocol (SIP) telephone, a wireless local loop (WLL) station, a personal digital assistant (PDA) device, a handheld device with wireless communication capabilities, a computing device, other processing devices connected to wireless modems, an on-board device, a wearable device, a user equipment in a future 5G network or in a future evolved PLMN network, and so on.

The network device 101 may be an access network device (or access network station). The access network device is a device that has the function of providing network access, such as a radio access network (RAN) base station and the like. The network device may include a base station (BS) device, or include a BS device and a wireless resource management device for controlling the BS device, and the like. The network device may also include relay stations (relay devices), access points, and base stations in the future 5G network, and base stations or NR base stations in the future evolved PLMN network, and the like. The network device may be a wearable device or an on-board device. The network device can also be a communication chip with a communication module.

For example, the network device 101 includes, but is not limited to, a next-generation base station (gnodeB, gNB) in 5G, an evolved node B (eNB) in an LTE system, a radio network controller (RNC), a node B (NB) in a wideband code division multiple access (WCDMA) system, a wireless controller in a centralized radio access network (CRAN) system, a base station controllers (BSC), a base transceiver station (BTS) in a global system for mobile communication (GSM) or code division multiple access (CDMA) system, and a home base stations (e.g., home evolved node B, or home node B (HNB)), a baseband unit (BBU), a transmitting and receiving point (TRP), a transmitting point (TP), or a mobile switching center.

Considering that the first channel for the main transceiver is a channel applied in a radio resource control (RRC) idle state or a RRC connected state, and the second channel for the low-power receiver is a broadcast channel applied in RRC ultra-idle state, among the multiple UEs in the cell, some user UEs are in RRC ultra-idle state, and some user UEs are in RRC idle/RRC connected state, so the base station will transmit two channels at the same time. For a UE, the time-frequency resource of the second channel broadcast by the base station can be known without having to monitor the two channels simultaneously. However, when the time-frequency resource of the first channel and the time-frequency resource of the second channel have an overlapping region, the monitoring of the user equipment on the overlapping region may be affected.

Therefore, it is necessary to consider how to prevent the problems caused by the conflict between the time-frequency resource of the first channel and the time-frequency resource of the second channel.

An embodiment of the present disclosure provides a method for monitoring information. FIG. 2 is a flowchart illustrating a method for monitoring information according to the embodiment of the present disclosure. As shown in FIG. 2, the method includes the following steps S201 to S203.

At step S201, the network device transmits first resource configuration information and second resource configuration information to the user equipment.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

At step S202, when the first time-frequency resource and the second time-frequency resource do not have an overlapping region, the network device transmits the first channel on the first time-frequency resource and transmits the second channel on the second time-frequency resource; when the first time-frequency resource and the second time-frequency resource have an overlapping region, one of the first channel and the second channel is not transmitted on the overlapping region, that is, only one of the first channel and the second channel is monitored on the overlapping region.

In some embodiments, the step S202 further includes: when the first time-frequency resource and the second time-frequency resource have an overlapping region, the network device transmits the first channel on the time-frequency resource except the overlapping region in the first time-frequency resource and transmits the second channel on the time-frequency resource except the overlapping region in the second time-frequency resource.

Transmitting one of the first channel and the second channel not on the overlapping region may also be expressed as not transmitting one of the first channel and the second channel on the overlapping region.

In some possible implementations, which of the first channel and the second channel is not transmitted on the overlapping region is determined based on the first channel.

In some embodiments, not transmitting one of the first channel and the second channel on the overlapping region includes: not transmitting the first channel on the overlapping region when the first channel is a physical downlink control channel (PDCCH) candidate; where the overlapping region is at least one resource element (RE) in the PDCCH candidate, that is, one or more resource elements in the PDCCH candidate overlap with the time-frequency resource of the second channel.

In some embodiments, not transmitting one of the first channel and the second channel on the overlapping region includes: not transmitting the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not transmitting one of the first channel and the second channel on the overlapping region includes: not transmitting the first channel on the overlapping region when the first channel is being used by a reference signal (RS). The time-frequency resource of the channel used by the reference signal overlaps with the time-frequency resource of the second channel.

In an example, the reference signal is a channel state information-reference signal (CSI-RS).

In the above-mentioned embodiments, if the overlapping region is all of the first time-frequency resource, the network device does not transmit the first channel, and if the overlapping region is a portion of the first time-frequency resource, the network device does not transmit the first channel on the overlapping region, and transmits the first channel in the first time-frequency resource in a region other than the overlapping region.

In some embodiments, not transmitting one of the first channel and the second channel on the overlapping region includes: not transmitting the second channel on the overlapping region when the first channel is being used by a synchronization signal.

In an example, the synchronization signal is a synchronization signal block (SSB), and this SSB consists of a primary synchronization signal (PSS), a secondary synchronization signal (SSS), and a physical broadcast channel (PBCH).

At step S203, when the first time-frequency resource and the second time-frequency resource do not have an overlapping region, the user equipment monitors the first channel on the first time-frequency resource and monitors the second channel on the second time-frequency resource; when the first time-frequency resource and the second time-frequency resource have an overlapping region, the user equipment does not monitor one of the first channel and the second channel on the overlapping region, that is, only one of the first channel and the second channel is monitored on the overlapping region.

In some embodiments, the step S203 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

Monitoring one of the first channel and the second channel not on the overlapping region may also be expressed as not monitoring one of the first channel and the second channel on the overlapping region.

In some possible implementations, which of the first channel and the second channel is not transmitted on the overlapping region is determined based on the first channel. The method by which the user equipment determines which of the first channel and the second channel to be not monitored on the overlapping region based on the first channel is the same as the method by which the network device determines which of the first channel and the second channel to be not transmitted on the overlapping region based on the first channel.

In some embodiments, not monitoring one of the first channel and the second channel on the overlapping region includes: not monitoring the first channel on the overlapping region when the first channel is a physical downlink control channel (PDCCH) candidate; where the overlapping region is at least one resource element (RE) in the PDCCH candidate, i.e., one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not monitoring one of the first channel and the second channel on the overlapping region includes: not monitoring the first channel on the overlapping region when the first channel is being used by a reference signal (RS). The time-frequency resource of the channel used by the reference signal overlaps with the time-frequency resource of the second channel.

In an example, the reference signal is a CSI-RS.

In some embodiments, not monitoring one of the first channel and the second channel on the overlapping region includes: not monitoring the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

In the embodiments of the present disclosure, in the scenario of using the user equipment with both the main transceiver and the low-power receiver, when the first time-frequency resource corresponding to the first channel for the main transceiver and the second time-frequency resource corresponding to the second channel for the low-power receiver have the overlapping region, the first channel and the second channel are not transmitted at the same time on the overlapping region, thereby the channel reception problem caused by resource conflicts is avoided.

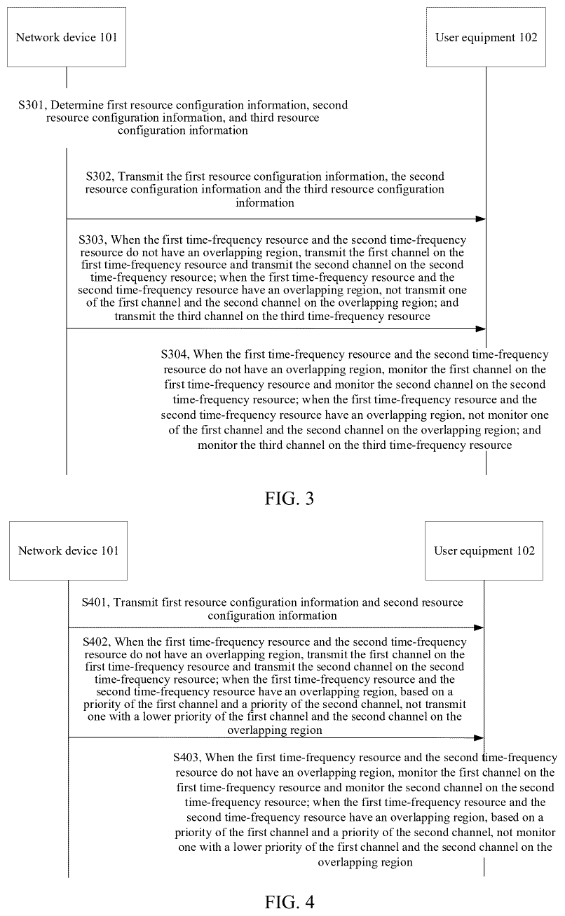

An embodiment of the present disclosure provides a method for monitoring information. FIG. 3 is a flowchart illustrating a method for monitoring information according to the embodiment of the present disclosure. As shown in FIG. 3, the method includes the following steps S301 to S304.

At step S301, first resource configuration information, second resource configuration information, and third resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity or a periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S302, the network device transmits the first resource configuration information, the second resource configuration information and the third resource configuration information to the user equipment.

At step S303, when the first time-frequency resource and the second time-frequency resource do not have an overlapping region, the network device transmits the first channel on the first time-frequency resource and transmits the second channel on the second time-frequency resource; when the first time-frequency resource and the second time-frequency resource have an overlapping region, one of the first channel and the second channel is not transmitted on the overlapping region. The network device transmits the third channel on the third time-frequency resource.

Transmitting one of the first channel and the second channel not on the overlapping region may also be expressed as not transmitting one of the first channel and the second channel on the overlapping region.

In some possible implementations, which of the first channel and the second channel is not transmitted on the overlapping region is determined based on the first channel.

In some embodiments, not transmitting one of the first channel and the second channel on the overlapping region includes: not transmitting the first channel on the overlapping region when the first channel is a physical downlink control channel (PDCCH) candidate; where the overlapping region is at least one resource element (RE) in the PDCCH candidate, that is, one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not transmitting one of the first channel and the second channel on the overlapping region includes: not transmitting the first channel on the overlapping region when the first channel is being used by a reference signal (RS). The time-frequency resource of the channel used by the reference signal overlaps with the time-frequency resource of the second channel.

In an example, the reference signal is a CSI-RS.

In the above-mentioned embodiments, if the overlapping region is all of the first time-frequency resource, the network device does not transmit the first channel, and if the overlapping region is a portion of the first time-frequency resource, the network device does not transmit the first channel on the overlapping region, and transmits the first channel in the first time-frequency resource in a region other than the overlapping region.

In some embodiments, not transmitting one of the first channel and the second channel on the overlapping region includes: not transmitting the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

At step S304, when the first time-frequency resource and the second time-frequency resource do not have an overlapping region, the user equipment monitors the first channel on the first time-frequency resource and monitors the second channel on the second time-frequency resource; when the first time-frequency resource and the second time-frequency resource have an overlapping region, the user equipment does not monitor one of the first channel and the second channel on the overlapping region. The user equipment monitors the third channel on the third time-frequency resource.

In some embodiments, the step S304 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

Monitoring one of the first channel and the second channel not on the overlapping region may also be expressed as not monitoring one of the first channel and the second channel on the overlapping region.

In some possible implementations, which of the first channel and the second channel is not transmitted on the overlapping region is determined based on the first channel. The method by which the user equipment determines which of the first channel and the second channel to be not monitored on the overlapping region based on the first channel is the same as the method by which the network device determines which of the first channel and the second channel to be not monitored on the overlapping region based on the first channel.

In some embodiments, not monitoring one of the first channel and the second channel on the overlapping region includes: not monitoring the first channel on the overlapping region when the first channel is a physical downlink control channel (PDCCH) candidate; where the overlapping region is at least one resource element (RE) in the PDCCH candidate, i.e., one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not monitoring one of the first channel and the second channel on the overlapping region includes: not monitoring the first channel on the overlapping region when the first channel is being used by a reference signal (RS). The time-frequency resource of the channel used by the reference signal overlaps with the time-frequency resource of the second channel.

In an example, the reference signal is a CSI-RS.

In some embodiments, not monitoring one of the first channel and the second channel on the overlapping region includes: not monitoring the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

In the embodiments of the present disclosure, for the third channel used for the non-periodic signal received by the low-power receiver for the user device, a third time-frequency resource that does not overlap with the first time-frequency resource of the first channel is determined for the third channel in order to ensure that the first channel and the third channel are previously interfered with.

An embodiment of the present disclosure provides a method for monitoring information. FIG. 4 is a flowchart illustrating a method for monitoring information according to the embodiment of the present disclosure. As shown in FIG. 4, the method includes the following steps S401 to S403.

At step S401, the network device transmits first resource configuration information and second resource configuration information to the user equipment.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, and the second resource configuration information corresponds to a second time-frequency resource.

At step S402, when the first time-frequency resource and the second time-frequency resource do not have an overlapping region, the network device transmits the first channel on the first time-frequency resource and transmits the second channel on the second time-frequency resource; when the first time-frequency resource and the second time-frequency resource have an overlapping region, based on a priority of the first channel and a priority of the second channel, one with a lower priority of the first channel and the second channel is not transmitted on the overlapping region.

In some embodiments, the step S402 further includes: when the first time-frequency resource and the second time-frequency resource have an overlapping region, the network device transmit the first channel on the time-frequency resource except the overlapping region in the first time-frequency resource and transmits the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not transmitted on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not transmitted on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not transmitted on the overlapping region.

In an example, the reference signal is a CSI-RS.

In some embodiments, the first channel is used by the synchronization signal, and the priority of the first channel is considered to be higher than the priority of the second channel, and thus the second channel is not transmitted on the overlapping region.

In an example, the synchronization signal is an SSB, and this SSB consists of a primary synchronization signal (PSS), a secondary synchronization signal (SSS), and a physical broadcast channel (PBCH).

At step S403, when the first time-frequency resource and the second time-frequency resource do not have an overlapping region, the user equipment monitors the first channel on the first time-frequency resource and monitors the second channel on the second time-frequency resource; when the first time-frequency resource and the second time-frequency resource have an overlapping region, based on a priority of the first channel and a priority of the second channel, the user equipment does not monitor one with a lower priority of the first channel and the second channel on the overlapping region.

In some embodiments, the step S403 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

The following embodiments corresponds to the step S402.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not monitored on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not monitored on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not monitored on the overlapping region.

In an example, the reference signal is a CSI-RS.

In some embodiments, the first channel is used by the synchronization signal, and the priority of the first channel is considered to be higher than the priority of the second channel, and thus the second channel is not monitored on the overlapping region.

In an example, the synchronization signal is an SSB, and this SSB consists of a primary synchronization signal (PSS), a secondary synchronization signal (SSS), and a physical broadcast channel (PBCH).

In the embodiments of the present disclosure, in the scenario of using the user equipment with both the main transceiver and the low-power receiver, when the first time-frequency resource corresponding to the first channel for the main transceiver and the second time-frequency resource corresponding to the second channel for the low-power receiver have the overlapping region, it is determined based on the priority of the channel that a channel with lower priority is not transmitted on the overlapping region, thereby the channel reception problem caused by resource conflicts is avoided.

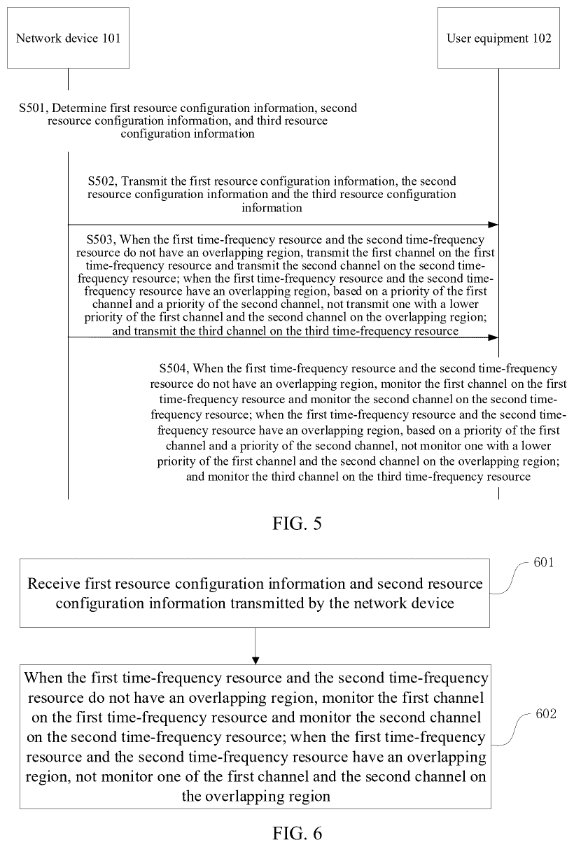

An embodiment of the present disclosure provides a method for monitoring information. FIG. 5 is a flowchart illustrating a method for monitoring information according to the embodiment of the present disclosure. As shown in FIG. 5, the method includes the following steps S501 to S504.

At step S501, first resource configuration information, second resource configuration information, and third resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S502, the network device transmits the first resource configuration information, the second resource configuration information and the third resource configuration information to the user equipment.

At step S503, when the first time-frequency resource and the second time-frequency resource do not have an overlapping region, the network device transmits the first channel on the first time-frequency resource and transmits the second channel on the second time-frequency resource; when the first time-frequency resource and the second time-frequency resource have an overlapping region, based on a priority of the first channel and a priority of the second channel, one with a lower priority of the first channel and the second channel is not transmitted on the overlapping region. The network device transmits the third channel on the third time-frequency resource.

In some embodiments, the step S502 further includes: when the first time-frequency resource and the second time-frequency resource have an overlapping region, the network device transmit the first channel on the time-frequency resource except the overlapping region in the first time-frequency resource and transmits the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the second channel. Thus, the first channel is not transmitted on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not transmitted on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not transmitted on the overlapping region.

In an example, the reference signal is a CSI-RS.

In some embodiments, the first channel is used by the synchronization signal, and the priority of the first channel is considered to be higher than the priority of the second channel, and thus the second channel is not transmitted on the overlapping region.

In an example, the synchronization signal is an SSB, and this SSB consists of a primary synchronization signal (PSS), a secondary synchronization signal (SSS), and a physical broadcast channel (PBCH).

At step S504, when the first time-frequency resource and the second time-frequency resource do not have an overlapping region, the user equipment monitors the first channel on the first time-frequency resource and monitors the second channel on the second time-frequency resource; when the first time-frequency resource and the second time-frequency resource have an overlapping region, based on a priority of the first channel and a priority of the second channel, the user equipment does not monitor one with a lower priority of the first channel and the second channel on the overlapping region. The third channel is monitored on the third time-frequency resource.

In some embodiments, the step S504 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

The following embodiments corresponds to the step S503.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not monitored on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not monitored on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not monitored on the overlapping region.

In an example, the reference signal is a CSI-RS.

In some embodiments, the first channel is used by the synchronization signal, and the priority of the first channel is considered to be higher than the priority of the second channel, and thus the second channel is not monitored on the overlapping region.

In an example, the synchronization signal is an SSB, and this SSB consists of a primary synchronization signal (PSS), a secondary synchronization signal (SSS), and a physical broadcast channel (PBCH).

An embodiment of the present disclosure provides a method for monitoring information, and the method is performed by a user equipment. FIG. 6 is a flowchart illustrating a method for monitoring information according to the embodiment of the present disclosure. As shown in FIG. 6, the method includes the following steps S601 to S602.

At step S601, first resource configuration information and second resource configuration information transmitted by the network device are received.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

At step S602, when the first time-frequency resource and the second time-frequency resource do not have an overlapping region, the first channel is monitored on the first time-frequency resource and the second channel is monitored on the second time-frequency resource; when the first time-frequency resource and the second time-frequency resource have an overlapping region, one of the first channel and the second channel is not monitored on the overlapping region, that is, only one of the first channel and the second channel is monitored on the overlapping region.

In some embodiments, the step S602 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

Monitoring one of the first channel and the second channel not on the overlapping region may also be expressed as not monitoring one of the first channel and the second channel on the overlapping region.

In some possible implementations, which of the first channel and the second channel is not transmitted on the overlapping region is determined based on the first channel.

In some embodiments, not monitoring one of the first channel and the second channel on the overlapping region includes: not monitoring the first channel on the overlapping region when the first channel is a physical downlink control channel (PDCCH) candidate; where the overlapping region is at least one resource element (RE) in the PDCCH candidate, i.e., one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not monitoring one of the first channel and the second channel on the overlapping region includes: not monitoring the first channel on the overlapping region when the first channel is being used by a reference signal (RS). The time-frequency resource of the channel used by the reference signal overlaps with the time-frequency resource of the second channel.

In an example, the reference signal is a CSI-RS.

In some embodiments, not monitoring one of the first channel and the second channel on the overlapping region includes: not monitoring the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

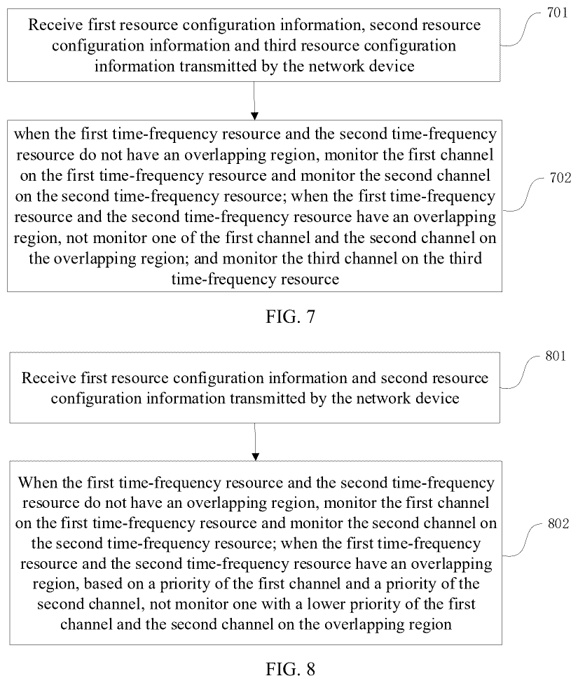

An embodiment of the present disclosure provides a method for monitoring information. FIG. 7 is a flowchart illustrating a method for monitoring information according to the embodiment of the present disclosure. As shown in FIG. 7, the method includes the following steps S701 to S702.

At step S701, first resource configuration information, second resource configuration information and third resource configuration information transmitted by the network device are received.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S702, when the first time-frequency resource and the second time-frequency resource do not have an overlapping region, the first channel is monitored on the first time-frequency resource and the second channel is monitored on the second time-frequency resource; when the first time-frequency resource and the second time-frequency resource have an overlapping region, one of the first channel and the second channel is not monitored on the overlapping region; and the third channel is monitored on the third time-frequency resource.

In some embodiments, the step S702 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

Monitoring one of the first channel and the second channel not on the overlapping region may also be expressed as not monitoring one of the first channel and the second channel on the overlapping region.

In some possible implementations, which of the first channel and the second channel is not transmitted on the overlapping region is determined based on the first channel.

In some embodiments, not monitoring one of the first channel and the second channel on the overlapping region includes: not monitoring the first channel on the overlapping region when the first channel is a physical downlink control channel (PDCCH) candidate; where the overlapping region is at least one resource element (RE) in the PDCCH candidate, i.e., one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not monitoring one of the first channel and the second channel on the overlapping region includes: not monitoring the first channel on the overlapping region when the first channel is being used by a reference signal (RS). The time-frequency resource of the channel used by the reference signal overlaps with the time-frequency resource of the second channel.

In an example, the reference signal is a CSI-RS.

In some embodiments, not monitoring one of the first channel and the second channel on the overlapping region includes: not monitoring the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

An embodiment of the present disclosure provides a method for monitoring information, and the method is performed by a user equipment. FIG. 8 is a flowchart illustrating a method for monitoring information according to the embodiment of the present disclosure. As shown in FIG. 8, the method includes the following steps S801 to S802.

At step S801, first resource configuration information and second resource configuration information transmitted by the network device are received.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

At step S802, when the first time-frequency resource and the second time-frequency resource do not have an overlapping region, the first channel is monitored on the first time-frequency resource and the second channel is monitored on the second time-frequency resource; when the first time-frequency resource and the second time-frequency resource have an overlapping region, based on a priority of the first channel and a priority of the second channel, one with a lower priority of the first channel and the second channel is not monitored on the overlapping region.

In some embodiments, the step S802 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not monitored on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not monitored on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not monitored on the overlapping region.

In an example, the reference signal is a CSI-RS.

In some embodiments, the first channel is used by the synchronization signal, and the priority of the first channel is considered to be higher than the priority of the second channel, and thus the second channel is not monitored on the overlapping region.

In an example, the synchronization signal is an SSB, and this SSB consists of a primary synchronization signal (PSS), a secondary synchronization signal (SSS), and a physical broadcast channel (PBCH).

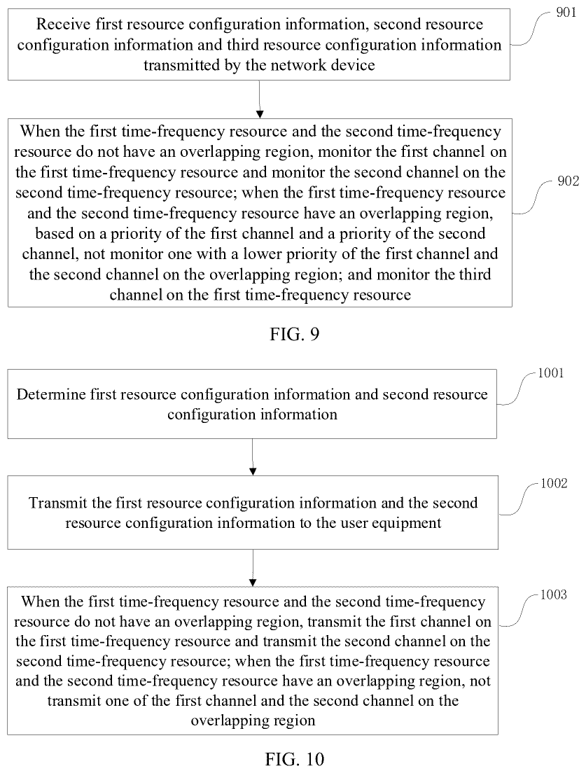

An embodiment of the present disclosure provides a method for monitoring information, and the method is performed by a user equipment. FIG. 9 is a flowchart illustrating a method for monitoring information according to the embodiment of the present disclosure. As shown in FIG. 9, the method includes the following steps S901 to S902.

At step S901, first resource configuration information, second resource configuration information and third resource configuration information transmitted by the network device are received.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S902, when the first time-frequency resource and the second time-frequency resource do not have an overlapping region, the first channel is monitored on the first time-frequency resource and the second channel is monitored on the second time-frequency resource; when the first time-frequency resource and the second time-frequency resource have an overlapping region, based on a priority of the first channel and a priority of the second channel, one with a lower priority of the first channel and the second channel is not monitored on the overlapping region; and the third channel is monitored on the first time-frequency resource.

In some embodiments, the step S902 further includes: when the first time-frequency resource and the second time-frequency resource have an overlapping region, the user equipment monitors the first channel on the time-frequency resource except the overlapping region in the first time-frequency resource and monitors the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not monitored on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not monitored on the overlapping region, i.e., the information in the PDSCH is not mapped to the RE on the overlapping region when resource mapping is performed.

In some embodiments, the first channel is used by the reference signal (RS), the first channel is considered to have a lower priority than the priority of the second channel, and thus the first channel is not monitored on the overlapping region.

In an example, the reference signal is a CSI-RS.

In some embodiments, the first channel is used by the synchronization signal, and the priority of the first channel is considered to be higher than the priority of the second channel, and thus the second channel is not monitored on the overlapping region.

In an example, the synchronization signal is an SSB, and this SSB consists of a primary synchronization signal (PSS), a secondary synchronization signal (SSS), and a physical broadcast channel (PBCH).

An embodiment of the present disclosure provides a method for transmitting information, and the method is performed by a network device. FIG. 10 is a flowchart illustrating a method for transmitting information according to the embodiment of the present disclosure. As shown in FIG. 10, the method includes the following steps S1001 to S1003.

At step S1001, first resource configuration information, and second resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

At step S1002, the first resource configuration information and the second resource configuration information are transmitted to the user equipment.

At step S1003, when the first time-frequency resource and the second time-frequency resource do not have an overlapping region, the first channel is transmitted on the first time-frequency resource and the second channel is transmitted on the second time-frequency resource; when the first time-frequency resource and the second time-frequency resource have an overlapping region, one of the first channel and the second channel is not transmitted on the overlapping region, that is, only one of the first channel and the second channel is monitored on the overlapping region.

Transmitting one of the first channel and the second channel not on the overlapping region may also be expressed as not transmitting one of the first channel and the second channel on the overlapping region.

In some possible implementations, which of the first channel and the second channel is not transmitted on the overlapping region is determined based on the first channel.

In some embodiments, not transmitting one of the first channel and the second channel on the overlapping region includes: not transmitting the first channel on the overlapping region when the first channel is a physical downlink control channel (PDCCH) candidate; where the overlapping region is at least one resource element (RE) in the PDCCH candidate, that is, one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), that is, the information in the PDSCH is not mapped on the RE on the overlapping region when performing resource mapping, where the overlapping region includes at least one resource element (RE) in the PDSCH, that is, one or more resource elements in the PDSCH overlap with the time-frequency resource of the second channel.

In some embodiments, not transmitting one of the first channel and the second channel on the overlapping region includes: not transmitting the first channel on the overlapping region when the first channel is being used by a reference signal (RS), i.e., the network device does not transmit a reference signal on the overlapping region, or the network device does not transmit the reference signal. The time-frequency resource of the channel used by the reference signal overlaps with the time-frequency resource of the second channel.

In an example, the reference signal is a CSI-RS.

In the above-mentioned embodiments, if the overlapping region is all of the first time-frequency resource, the network device does not transmit the first channel, and if the overlapping region is a portion of the first time-frequency resource, the network device does not transmit the first channel on the overlapping region, and transmits the first channel in the first time-frequency resource in a region other than the overlapping region.

In some embodiments, not transmitting one of the first channel and the second channel on the overlapping region includes: not transmitting the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

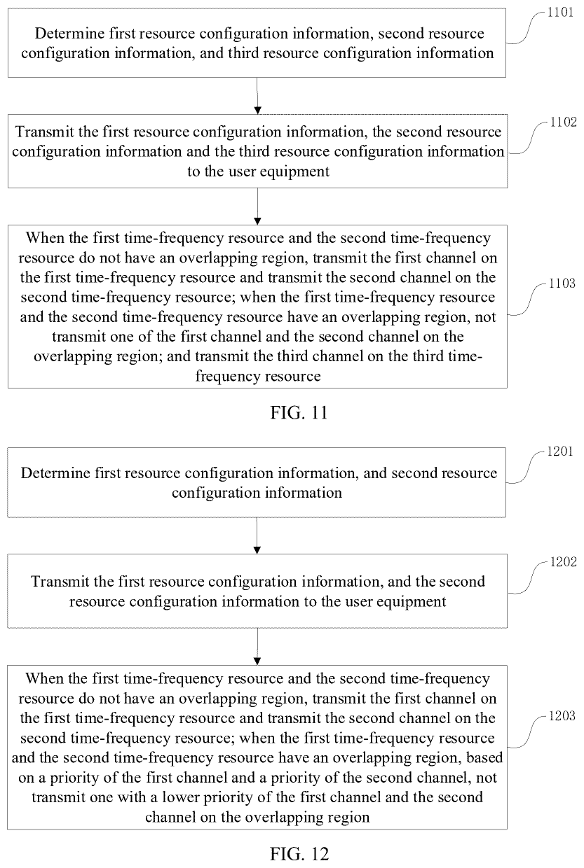

An embodiment of the present disclosure provides a method for transmitting information, and the method is performed by a network device. FIG. 11 is a flowchart illustrating a method for transmitting information according to the embodiment of the present disclosure. As shown in FIG. 11, the method includes the following steps S1101 to S1103.

At step S1101, first resource configuration information, second resource configuration information, and third resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S1102, the first resource configuration information, the second resource configuration information and the third resource configuration information are transmitted to the user equipment.

At step S1103, when the first time-frequency resource and the second time-frequency resource do not have an overlapping region, the first channel is transmitted on the first time-frequency resource and the second channel is transmitted on the second time-frequency resource; when the first time-frequency resource and the second time-frequency resource have an overlapping region, one of the first channel and the second channel is not transmitted on the overlapping region; and the third channel is transmitted on the third time-frequency resource.

Transmitting one of the first channel and the second channel not on the overlapping region may also be expressed as not transmitting one of the first channel and the second channel on the overlapping region.

In some possible implementations, which of the first channel and the second channel is not transmitted on the overlapping region is determined based on the first channel.

In some embodiments, not transmitting one of the first channel and the second channel on the overlapping region includes: not transmitting the first channel on the overlapping region when the first channel is a physical downlink control channel (PDCCH) candidate; where the overlapping region is at least one resource element (RE) in the PDCCH candidate, that is, one or more resource elements in the PDCCH candidate overlap with the time-frequency resource of the second channel.

In some embodiments, not monitoring one of the first channel and the second channel on the overlapping region includes: not monitoring the first channel on the overlapping region when the first channel is a physical downlink shared channel (PDSCH), where the overlapping region includes at least one resource element (RE) in the PDSCH, that is, one or more resource elements in the PDSCH overlap with the time-frequency resource of the second channel.

In some embodiments, not transmitting one of the first channel and the second channel on the overlapping region includes: not transmitting the first channel on the overlapping region when the first channel is being used by a reference signal (RS). The time-frequency resource of the channel used by the reference signal overlaps with the time-frequency resource of the second channel.

In an example, the reference signal is a CSI-RS.

In the above-mentioned embodiments, if the overlapping region is all of the first time-frequency resource, the network device does not transmit the first channel, and if the overlapping region is a portion of the first time-frequency resource, the network device does not transmit the first channel on the overlapping region, and transmits the first channel in the first time-frequency resource in a region other than the overlapping region.

In some embodiments, not transmitting one of the first channel and the second channel on the overlapping region includes: not transmitting the second channel on the overlapping region when the first channel is being used by a synchronization signal.

In an example, the synchronization signal is an SSB, and this SSB consists of a primary synchronization signal (PSS), a secondary synchronization signal (SSS), and a physical broadcast channel (PBCH).

An embodiment of the present disclosure provides a method for transmitting information. FIG. 12 is a flowchart illustrating a method for transmitting information according to the embodiment of the present disclosure. As shown in FIG. 12, the method includes the following steps S1201 to S1203.

At step S1201, first resource configuration information, and second resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, i.e., the second channel is a broadcast channel, and the second resource configuration information corresponds to a second time-frequency resource.

At step S1202, the first resource configuration information and the second resource configuration information are transmitted to the user equipment.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver of the user equipment, and the second resource configuration information corresponds to a second time-frequency resource.

At step S1203, when the first time-frequency resource and the second time-frequency resource do not have an overlapping region, the first channel is transmitted on the first time-frequency resource and the second channel is transmitted on the second time-frequency resource; when the first time-frequency resource and the second time-frequency resource have an overlapping region, based on a priority of the first channel and a priority of the second channel, one with a lower priority of the first channel and the second channel is not transmitted on the overlapping region.

In some embodiments, the step S1203 further includes: when the first time-frequency resource and the second time-frequency resource have an overlapping region, the network device transmit the first channel on the time-frequency resource except the overlapping region in the first time-frequency resource and transmits the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the second channel. Thus, the first channel is not transmitted on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not transmitted on the overlapping region.

In some embodiments, the first channel is used by the reference signal (RS), the first channel is considered to have a lower priority than the priority of the second channel, and thus the first channel is not transmitted on the overlapping region.

In an example, the reference signal is a CSI-RS.

In some embodiments, the first channel is used by the synchronization signal, and the priority of the first channel is considered to be higher than the priority of the second channel, and thus the second channel is not transmitted on the overlapping region.

In an example, the synchronization signal is an SSB, and this SSB consists of a primary synchronization signal (PSS), a secondary synchronization signal (SSS), and a physical broadcast channel (PBCH).

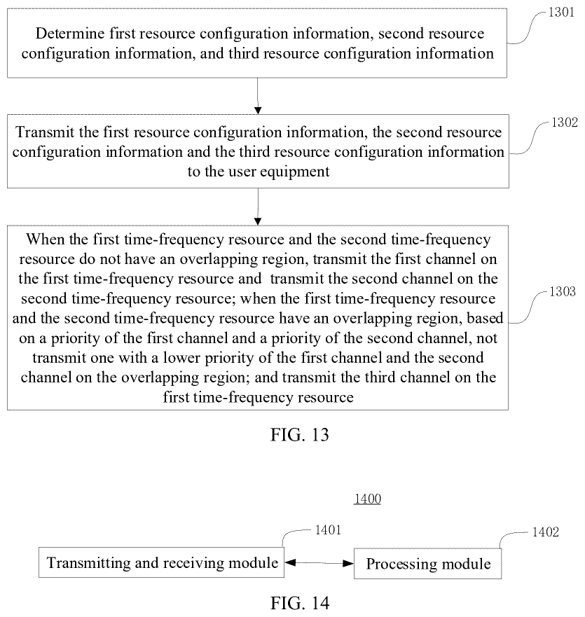

An embodiment of the present disclosure provides a method for transmitting information, and the method is performed by a network device. FIG. 13 is a flowchart illustrating a method for transmitting information according to the embodiment of the present disclosure. As shown in FIG. 13, the method includes the following steps S1301 to S1303.

At step S1301, first resource configuration information, second resource configuration information, and third resource configuration information are determined.

The first resource configuration information is resource configuration information for a first channel, the first channel is configured for reception by a main transceiver of the user equipment, and the first resource configuration information corresponds to a first time-frequency resource.

The second resource configuration information is resource configuration information for a second channel, the second channel is configured for a periodic signal received by a low-power receiver, i.e., the second channel is a broadcast channel, and the second resource configuration information corresponds to a second time-frequency resource.

The third resource configuration information is the resource configuration information of the third channel, which is used for the low-power receiver of the user equipment to receive a non-periodic signal (which can be transmitted at non-periodic detection opportunity). The third resource configuration information corresponds to the third time-frequency resource.

Considering that the user equipment does not expect the non-periodic signal applied to the low-power receiver to overlap with the channel applied to the main transceiver, the network equipment needs to ensure at the time of scheduling that: the non-periodic signal applied to the low-power receiver does not overlap with the signal applied to the main transceiver, so that the third resource configuration information and the first resource configuration information do not have an overlapping region.

At step S1302, the first resource configuration information, the second resource configuration information and the third resource configuration information are transmitted to the user equipment.

At step S1303, when the first time-frequency resource and the second time-frequency resource do not have an overlapping region, the first channel is transmitted on the first time-frequency resource and the second channel is transmitted on the second time-frequency resource; when the first time-frequency resource and the second time-frequency resource have an overlapping region, based on a priority of the first channel and a priority of the second channel, one with a lower priority of the first channel and the second channel is not transmitted on the overlapping region; and the network device transmits the third channel on the first time-frequency resource.

In some embodiments, the step S1303 further includes: when the first time-frequency resource and the second time-frequency resource have an overlapping region, the network device transmit the first channel on the time-frequency resource except the overlapping region in the first time-frequency resource and transmits the second channel on the time-frequency resource except the overlapping region in the second time-frequency resource.

In some embodiments, when the first channel is a physical downlink control channel (PDCCH) candidate, the overlapping region is at least one resource element (RE) in the PDCCH candidate, and the first channel is considered to have a lower priority than the priority of the second channel. Thus, the first channel is not monitored on the overlapping region.

In some embodiments, the first channel is a physical downlink shared channel (PDSCH), and the overlapping region includes at least one resource element (RE) in the PDSCH, the first channel is considered to have a lower priority than the priority of the second channel, and thus the first channel is not transmitted on the overlapping region.

In some embodiments, the first channel is used by the reference signal (RS), the first channel is considered to have a lower priority than the priority of the second channel, and thus the first channel is not transmitted on the overlapping region.

In an example, the reference signal is a CSI-RS.

In some embodiments, the first channel is used by the synchronization signal, and the priority of the first channel is considered to be higher than the priority of the second channel, and thus the second channel is not transmitted on the overlapping region.

In an example, the synchronization signal is an SSB, and this SSB consists of a primary synchronization signal (PSS), a secondary synchronization signal (SSS), and a physical broadcast channel (PBCH).

Based on the same conception as the method embodiments, embodiments of the present disclosure further provide a communication device that may have the functions of the user equipment 102 in the method embodiments and be used to perform the steps provided in the above-mentioned embodiments and performed by the user equipment 102. The functions may be implemented by software, or by hardware executing corresponding software. The hardware or software includes one or more modules corresponding to the above-mentioned functions.

In an embodiment, the communication apparatus 1400 as shown in FIG. 14 may serve as the user equipment 102 involved in the method embodiments and perform the steps performed by the user equipment 102 in the method embodiments.

The communication apparatus 1400 includes a transmitting and receiving module 1401, and a processing module 1402.

The transmitting and receiving module 1401 is configured to: receive first resource configuration information and second resource configuration information, where the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and in response to the first time-frequency resource and the second time-frequency resource having an overlapping region, not monitor, on the overlapping region, one of the first channel and the second channel.

In some embodiments, the processing module 1401 is configured to, based on a priority of the first channel and a priority of the second channel, not monitor, on the overlapping region, one with a lower priority of the first channel and the second channel.

In some embodiments, the transmitting and receiving module 1401 is further configured to, in response to the first channel being a physical downlink control channel (PDCCH) candidate, not monitor, on the overlapping region, the first channel.

In some embodiments, the transmitting and receiving module 1401 is further configured to, in response to the first channel being a physical downlink shared channel (PDSCH), not monitor, on the overlapping region, the first channel.

In some embodiments, the transmitting and receiving module 1401 is further configured to, in response to the first channel being used by a reference signal, not monitor, on the overlapping region, the first channel.

In some embodiments, the transmitting and receiving module 1401 is further configured to, in response to the first channel being used by a synchronization signal, not monitor, on the overlapping region, the second channel.

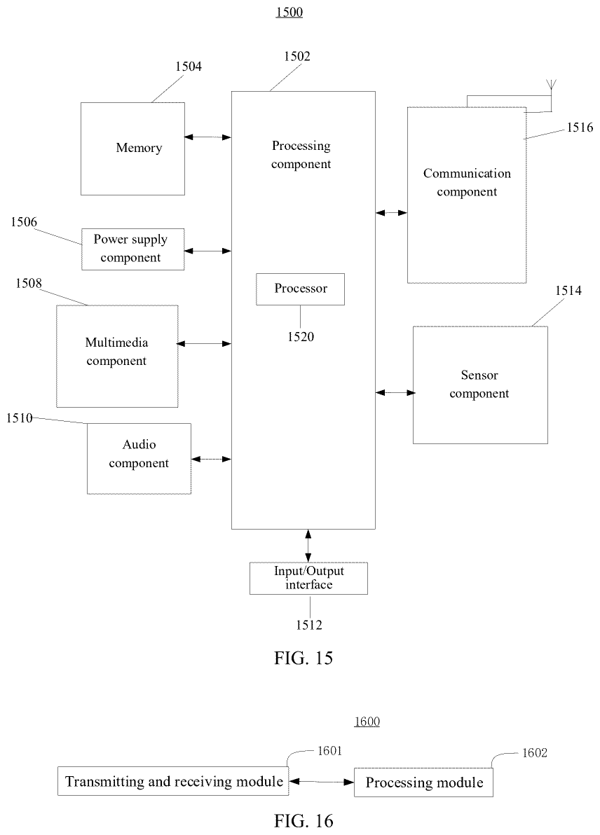

When a communication device is a user equipment 102, its structure may also be shown in FIG. 15. Referring to FIG. 15, the device 1500 can include one or more of the following components: a processing component 1502, a memory 1504, a power supply component 1506, a multimedia component 1508, an audio component 1510, an input/output (I/O) interface 1512, a sensor component 1514, and a communication component 1516.

The processing component 1502 usually controls overall operations of the device 1500, such as operations related to display, a telephone call, data communication, a camera operation and a record operation. The processing component 1502 may include one or more processors 1520 to execute instructions to complete all or a part of the steps of the above methods. Further, the processing component 1502 may include one or more modules to facilitate interaction between the processing component 1502 and another component. For example, the processing component 1502 may include a multimedia module to facilitate the interaction between the multimedia component 1508 and the processing component 1502.

The memory 1504 is configured to store different types of data to support operations at the device 1500. Examples of such data include instructions, contact data, phone book data, messages, pictures, videos, and so on for any application or method that operates on the device 1500. The memory 1504 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1506 supplies power for different components of the device 1500. The power supply component 1506 may include a power supply management system, one or more power supplies, and other components associated with generating, managing and distributing power for the device 1500.

The multimedia component 1508 includes a screen for providing an output interface between the device 1500 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1508 may include a front camera and/or a rear camera. When the device 1500 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 1510 is configured to output and/or input an audio signal. For example, the audio component 1510 may include a microphone (MIC). When the device 1500 is in an operating mode, such as a call mode, a recording mode and a speech recognition mode, the microphone is configured to receive an external audio signal. The received audio signal may be further stored in the memory 1504 or sent via the communication component 1516. In some embodiments, the audio component 1510 also includes a speaker for outputting an audio signal.

The I/O interface 1512 may provide an interface between the processing component 1502 and peripheral interface modules. The above peripheral interface modules may include a keyboard, a click wheel, buttons and so on. Such buttons may include but not limited to: a home button, a volume button, a start button and a lock button.

The sensor component 1514 includes one or more sensors for providing state assessments in different aspects for the device 1500. For example, the sensor component 1514 may detect an on/off state of the device 1500 and a relative location of components. For example, the components are a display and a keypad of the device 1500. The sensor component 1514 may also detect a position change of the device 1500 or a component of the device 1500, presence or absence of a touch of a user on the device 1500, an orientation or acceleration/deceleration of the device 1500, and a temperature change of the device 1500. The sensor component 1514 may include a proximity sensor configured to detect presence of a nearby object without any physical contact. The sensor component 1514 may also include an optical sensor, such as a CMOS or CCD image sensor used in an imaging application. In some embodiments, the sensor component 1514 may also include an acceleration sensor, a gyroscope sensor, a magnetic sensor, a pressure sensor, or a temperature sensor.

The communication component 1516 is configured to facilitate wired or wireless communication between the device 1500 and other devices. The device 1500 may access a wireless network based on a communication standard, such as Wi-Fi, 4G or 5G, or a combination thereof. In some embodiments, the communication component 1516 may receive a broadcast signal or broadcast-related information from an external broadcast management system via a broadcast channel. In some embodiments, the communication component 1516 may also include a near field communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology and other technologies.

In an example, the device 1500 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 1504 including instructions, is also provided. The above instructions may be executed by the processor 1520 of the device 1500 to complete the above method. For example, the non-transitory computer readable storage medium may be a read-only memory (ROM), a random access memory (RAM), a CD-ROM, a magnetic tape, a floppy disk and an optical data storage device, etc.

Based on the same conception as the method embodiments, embodiments of the present disclosure further provide a communication device that may have the functions of the network device 101 in the method embodiments and be used to perform the steps provided in the above-mentioned embodiments and performed by the network device 101. The functions may be implemented by software, or by hardware executing corresponding software. The hardware or software includes one or more modules corresponding to the above-mentioned functions.

In an embodiment, the communication apparatus 1600 as shown in FIG. 16 may serve as the network device 101 involved in the method embodiments and perform the steps performed by the network device 101 in the method embodiments.

The communication apparatus 1600 includes a processing module 1602, or includes a transmitting and receiving module 1601 and a processing module 1602.

The transmitting and receiving module 1601 is configured to: transmit first resource configuration information and second resource configuration information to a user equipment, where the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and in response to the first time-frequency resource and the second time-frequency resource having an overlapping region, not transmit, on the overlapping region, one of the first channel and the second channel.

In some embodiments, the processing module 1602 is configured to, based on a priority of the first channel and a priority of the second channel, not transmit, on the overlapping region, one with a lower priority of the first channel and the second channel.

In some embodiments, the transmitting and receiving module 1601 is further configured to, in response to the first channel being a physical downlink control channel (PDCCH) candidate, not transmit, on the overlapping region, the first channel.

In some embodiments, the transmitting and receiving module 1601 is further configured to, in response to the first channel being a physical downlink shared channel (PDSCH), not transmit, on the overlapping region, the first channel.

In some embodiments, the transmitting and receiving module 1601 is further configured to, in response to the first channel being used by a reference signal, not transmit, on the overlapping region, the first channel.

In some embodiments, the transmitting and receiving module 1601 is further configured to, in response to the first channel being used by a synchronization signal, not transmit, on the overlapping region, the second channel.

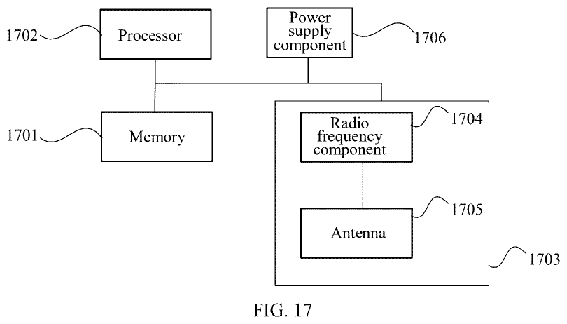

When a communication device is a network device 102, its structure may also be shown in FIG. 17. The structure of the communication device is illustrated by the example of the base station. As shown in FIG. 17, the communication device 1700 includes a memory 1701, a processor 1702, a transmitting and receiving component 1703, and a power supply component 1706. The memory 1701 is coupled to the processor 1702 and may be configured to store programs and data necessary for the communication device 1700 to implement various functions. The processor 1702 is configured to support the communication device 1700 to perform the corresponding function in the above-mentioned methods, which can be realized by calling the programs stored in the memory 1701. The transmitting and receiving component 1703 may be a wireless transceiver that may be used to support the communication device 1700 to receive signaling and/or data through a radio Interface, as well as to transmit signaling and/or data. The transmitting and receiving component 1703 may also be referred to as a transmitting and receiving unit or a communication unit, and the transmitting and receiving component 1703 may include an radio frequency (RF) component 1704 and one or more antennas 1705, where the RF component 1704 may be a remote radio unit (RRU), which may be specifically used for transmission of RF signals and conversion of RF signals to baseband signals, and the one or more antennas 1705 may be specifically used to perform radiation and reception of RF signals.

When the communication device 1700 needs to transmit data, the processor 1702 can perform baseband processing on the data to be transmitted, and then output a baseband signal to the radio frequency unit, and the radio frequency unit performs radio frequency processing on the baseband signal and then transmits the radio frequency signal in the form of electromagnetic waves through the antenna. When there is data transmitted to the communication device 1700, the radio frequency unit receives the radio frequency signal through the antenna, converts the radio frequency signal to a baseband signal, and outputs the baseband signal to the processor 1702, and the processor 1702 converts the baseband signal to data and processes the data.

In an example, a non-transitory computer readable storage medium including instructions, such as the memory 604 including instructions, is also provided. The above instructions may be executed by the processor 620 of the device 600 to complete the method. For example, the non-transitory computer readable storage medium may be a read-only memory (ROM), a random access memory (RAM), a CD-ROM, a magnetic tape, a floppy disk and an optical data storage device, etc.

After considering the specification and practicing the present disclosure, those skilled in the art would easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the present disclosure is to be limited only by the appended claims.

### INDUSTRIAL UTILITY

In the scenario of using the user equipment with both the main transceiver and the low-power receiver, when the first time-frequency resource corresponding to the first channel for the main transceiver and the second time-frequency resource corresponding to the second channel for the low-power receiver have the overlapping region, the first channel and the second channel are not transmitted at the same time on the overlapping region, thereby the channel reception problem caused by resource conflicts is avoided.

1. A method for monitoring information, performed by a user equipment, and comprising:
receiving first resource configuration information and second resource configuration information, wherein the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and
in response to the first time-frequency resource and the second time-frequency resource having an overlapping region, not monitoring, on the overlapping region, one of the first channel and the second channel.

2. The method of claim 1, wherein not monitoring, on the overlapping region, one of the first channel and the second channel comprises:
based on a priority of the first channel and a priority of the second channel, not monitoring, on the overlapping region, one with a lower priority of the first channel and the second channel.

3. The method of claim 1, wherein not monitoring, on the overlapping region, one of the first channel and the second channel comprises:
in response to the first channel being a physical downlink control channel (PDCCH) candidate, not monitoring, on the overlapping region, the first channel.

4. The method of claim 1, wherein not monitoring, on the overlapping region, one of the first channel and the second channel comprises:
in response to the first channel being a physical downlink shared channel (PDSCH), not monitoring, on the overlapping region, the first channel.

5. The method of claim wherein not monitoring, on the overlapping region, one of the first channel and the second channel comprises:
in response to the first channel being used by a reference signal, not monitoring, on the overlapping region, the first channel.

6. The method of claim 1, wherein not monitoring, on the overlapping region, one of the first channel and the second channel comprises:
in response to the first channel being used by a synchronization signal, not monitoring, on the overlapping region, the second channel.

7. A method for transmitting information, performed by a network device, and comprising:
transmitting first resource configuration information and second resource configuration information to a user equipment, wherein the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and
in response to the first time-frequency resource and the second time-frequency resource having an overlapping region, not transmitting, on the overlapping region, one of: the first channel and the second channel.

8. The method of claim 7, wherein not transmitting, on the overlapping region, one of the first channel and the second channel comprises:
based on a priority of the first channel and a priority of the second channel, not transmitting, on the overlapping region, one with a lower priority of the first channel and the second channel.

9. The method of claim 7, wherein not transmitting, on the overlapping region, one of the first channel and the second channel comprises:
in response to the first channel being a physical downlink control channel (PDCCH) candidate, not transmitting, on the overlapping region, the first channel.

10. The method of claim 7, wherein not transmitting, on the overlapping region, one of the first channel and the second channel comprises:
in response to the first channel being a physical downlink shared channel (PDSCH), not transmitting, on the overlapping region, the first channel.

11. The method of claim 7, wherein not transmitting, on the overlapping region, one of the first channel and the second channel comprises:
in response to the first channel being used by a reference signal, not transmitting, on the overlapping region, the first channel.

12. The method of claim wherein not transmitting, on the overlapping region, one of the first channel and the second channel comprises:
in response to the first channel being used by a synchronization signal, not transmitting, on the overlapping region, the second channel.

13.-14. (canceled)

15. An electronic device, comprising a processor and a memory, wherein
the memory is configured to store computer programs; and
the computer programs, when executed by the processor, cause the processor to perform operations comprising:
receiving first resource configuration information and second resource configuration information, wherein the first resource configuration information is resource configuration information for a first channel, the first channel is configured for reception by a main transceiver of the user equipment, the first resource configuration information corresponds to a first time-frequency resource, the second resource configuration information is resource configuration information for a second channel, the second channel is configured for a periodic signal received by a low-power receiver, and the second resource configuration information corresponds to a second time-frequency resource; and
in response to the first time-frequency resource and the second time-frequency resource having an overlapping region, not monitoring, on the overlapping region, one of the first channel and the second channel.

16. An electronic device, comprising a processor and a memory, wherein
the memory is configured to store computer programs; and
the computer programs, when executed by the processor, cause the processor to perform the method of claim 1.

17.-18. (canceled)

19. The electronic device of claim 15, wherein not monitoring, on the overlapping region, one of the first channel and the second channel comprises:
based on a priority of the first channel and a priority of the second channel, not monitoring, on the overlapping region, one with a lower priority of the first channel and the second channel.

20. The electronic device of claim 15, wherein not monitoring, on the overlapping region, one of the first channel and the second channel comprises:
in response to the first channel being a physical downlink control channel (PDCCH) candidate, not monitoring, on the overlapping region, the first channel.

21. The electronic device of claim 15, wherein not monitoring, on the overlapping region, one of the first channel and the second channel comprises:
in response to the first channel being a physical downlink shared channel (PDSCH), not monitoring, on the overlapping region, the first channel.

22. The electronic device of claim 15, wherein not monitoring, on the overlapping region, one of the first channel and the second channel comprises:
in response to the first channel being used by a reference signal, not monitoring, on the overlapping region, the first channel.

23. The electronic device of claim 15, wherein not monitoring, on the overlapping region, one of the first channel and the second channel comprises:
in response to the first channel being used by a synchronization signal, not monitoring, on the overlapping region, the second channel.
